(19) United States
(12) Patent Application Publication
(10) Pub. No.: US 2021/0099669 A1
(43) Pub. Date: Apr. 1, 2021

(54) IMAGE CAPTURING APPARATUS, COMMUNICATION SYSTEM, DATA DISTRIBUTION METHOD, AND NON-TRANSITORY RECORDING MEDIUM

(71) Applicants: Hideki Shiro, Kanagawa (JP); Hidekuni Annaka, Saitama (JP); Kenichiro Morita, Tokyo (JP); Takuya Soneda, Kanagawa (JP); Takeshi Homma, Kanagawa (JP); Kumiko Yoshida, Tokyo (JP)

(72) Inventors: Hideki Shiro, Kanagawa (JP); Hidekuni Annaka, Saitama (JP); Kenichiro Morita, Tokyo (JP); Takuya Soneda, Kanagawa (JP); Takeshi Homma, Kanagawa (JP); Kumiko Yoshida, Tokyo (JP)

(73) Assignee: Ricoh Company, Ltd.

(21) Appl. No.: 16/988,720

(22) Filed: Aug. 10, 2020

(30) Foreign Application Priority Data
Sep. 2, 2019 (JP) 2019-159326

(51) Int. Cl. H04N 7/04; H04N 5/232; G06F 3/14; G06T 3/00; G06K 7/14; H04L 29/06

(52) U.S. Cl. CPC H04N 7/04; H04N 5/23238; G06F 3/14; H04L 63/08; H04N 5/23206; G06K 7/1417; G06T 3/0062

(57) ABSTRACT

An image capturing apparatus includes an imaging device and circuitry. The imaging device captures an image of a subject to acquire image data. The circuitry reads a two-dimensional code displayed on a communication terminal and acquired with the imaging device, and acquires setting information for using a service provided by a content distribution system that distributes content via a communication network. The setting information is represented by the read two-dimensional code. The circuitry further connects the image capturing apparatus to the communication network with network connection information included in the acquired setting information, and distributes the image data acquired by the imaging device to the content distribution system via the communication network connected to the image capturing apparatus.

### CROSS-REFERENCE TO RELATED APPLICATION

This patent application is based on and claims priority pursuant to 35 U.S.C. § 119(a) to Japanese Patent Application No. 2019-159326 filed on Sep. 2, 2019 in the Japan Patent Office, the entire disclosure of which is hereby incorporated by reference herein.

### BACKGROUND

### Technical Field

The present invention relates to an image capturing apparatus, a communication system, a data distribution method, and a non-transitory recording medium.

### Description of the Related Art

In recent years, a technique has been widely used which enables an image captured with an image capturing apparatus to be distributed via a content distribution service on the Internet. There is also a system that directly connects the image capturing apparatus to the Internet, without via a communication terminal such as a personal computer (PC) or a smartphone, to enable the image distribution.

Such image distribution is implemented with the settings of information such as information for connecting to a network and authorization information for using the content distribution service. A typical image capturing apparatus, however, is not equipped with an input device and a display, unlike a PC or a smartphone, making it difficult to input a lot of information with the image capturing apparatus. To address this issue, there is a technique of forming a local network between the image capturing apparatus and the communication terminal such that various settings are input with the communication terminal and the information of the input settings is reflected in the image capturing apparatus via the local network.

According to this technique, however, the connection to the Internet is unavailable during the communication between the image capturing apparatus and the communication terminal. The setting information for using the content distribution service is typically obtained via the Internet, and the distribution of the image captured by the image capturing apparatus involves the connection to the Internet. According to the existing technique, therefore, the network connection is frequently switched during an operation, complicating the settings for the image distribution with the image capturing apparatus.

### SUMMARY

In one embodiment of this invention, there is provided an improved image capturing apparatus that includes, for example, an imaging device and circuitry. The imaging device captures an image of a subject to acquire image data. The circuitry reads a two-dimensional code displayed on a communication terminal and acquired with the imaging device, and acquires setting information for using a service provided by a content distribution system that distributes content via a communication network. The setting information is represented by the read two-dimensional code. The circuitry further connects the image capturing apparatus to the communication network with network connection information included in the acquired setting information, and distributes the image data acquired by the imaging device to the content distribution system via the communication network connected to the image capturing apparatus.

In one embodiment of this invention, there is provided an improved communication system that includes, for example, the above-described image capturing apparatus and a communication terminal. The communication terminal includes second circuitry. The second circuitry receives an input of setting request information for requesting settings for using the content distribution system, transmits the received setting request information to the content distribution system, and controls a display to display the two-dimensional code representing the setting information. The setting information includes the setting request information and service provision information for providing the service to a user.

In one embodiment of this invention, there is provided an improved data distribution method that includes, for example, capturing an image of a subject with an imaging device of the image capturing apparatus to acquire image data, reading a two-dimensional code displayed on a communication terminal and acquired with the imaging device, acquiring setting information for using a service provided by a content distribution system that distributes content via a communication network, connecting the image capturing apparatus to the communication network with network connection information included in the acquired setting information, and distributing the image data acquired by the imaging device to the content distribution system via the communication network connected to the image capturing apparatus. The setting information is represented by the read two-dimensional code.

In one embodiment of this invention, there is provided a non-transitory recording medium storing a plurality of instructions which, when executed by one or more processors, cause the processors to perform the above-described data distribution method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an exemplary system configuration of a communication system of a first embodiment of the present invention;

FIG. 2 is a diagram illustrating an exemplary hardware configuration of a communication terminal included in the communication system of the first embodiment;

FIG. 3 is a diagram illustrating an exemplary hardware configuration of each of a content distribution system, a client program distribution system, and a router included in the communication system of the first embodiment;

FIG. 4 is a diagram illustrating an exemplary hardware configuration of an image capturing apparatus included in the communication system of the first embodiment;

FIG. 5A is a diagram illustrating a front hemispherical image captured by a special image capturing apparatus as an example of the image capturing apparatus of the first embodiment;

FIG. 5B is a diagram illustrating a rear hemispherical image captured by the special image capturing apparatus;

FIG. 5C is a diagram illustrating an equirectangular projection image generated from the hemispherical images by equirectangular projection;

FIG. 6A is a conceptual diagram illustrating the equirectangular projection image covering a sphere;

FIG. 6B is a diagram illustrating an omnidirectional image obtained from the equirectangular projection image;

FIG. 7 is a diagram illustrating respective positions of a virtual camera and a viewable area of the omnidirectional image when the omnidirectional image is expressed as a three-dimensional solid sphere;

FIG. 8A is a perspective view of the omnidirectional image in FIG. 7 as the solid sphere;

FIG. 8B is a diagram illustrating an image of the viewable area displayed on a display;

FIG. 9 is a diagram illustrating the relationship between viewable area information and the image of the viewable area;

FIGS. 10A and 10B are diagrams illustrating an exemplary functional configuration of the communication system of the first embodiment;

FIG. 11A is a conceptual diagram illustrating an exemplary authentication management table of the first embodiment;

FIG. 11B is a conceptual diagram illustrating an exemplary authorization information management table of the first embodiment;

FIG. 11C is a conceptual diagram illustrating exemplary client program identification information of the first embodiment;

FIG. 12 is a sequence diagram illustrating an exemplary content distribution process performed in the communication system of the first embodiment;

FIG. 13 is a diagram illustrating an exemplary setting screen displayed on the communication terminal of the first embodiment;

FIG. 14 is a diagram illustrating an exemplary two-dimensional code displayed on the communication terminal of the first embodiment;

FIG. 15 is a sequence diagram illustrating an exemplary content distribution process performed in the communication system of the first embodiment;

FIG. 16 is a flowchart illustrating an exemplary setting information reading process performed by the communication terminal of the first embodiment;

FIG. 17A is a conceptual diagram illustrating an exemplary two-dimensional code acquired by the image capturing apparatus of the first embodiment;

FIG. 17B is a diagram illustrating an example of correction of the two-dimensional code by the image capturing apparatus of the first embodiment;

FIG. 18 is a conceptual diagram illustrating exemplary setting information included in the two-dimensional code of the first embodiment;

FIG. 19 is a diagram illustrating a first modified example of the two-dimensional code of the first embodiment displayed on the communication terminal;

FIG. 20 is a flowchart illustrating an exemplary process of generating the first modified example of the two-dimensional code of the first embodiment;

FIG. 21 is a diagram illustrating a second modified example of the two-dimensional code of the first embodiment displayed on the communication terminal;

FIGS. 22A and 22B are diagrams illustrating an exemplary functional configuration of a communication system of a second embodiment of the present invention; and

FIG. 23 is a sequence diagram illustrating an exemplary content distribution process performed in the communication system of the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A first embodiment of the present invention will be described.

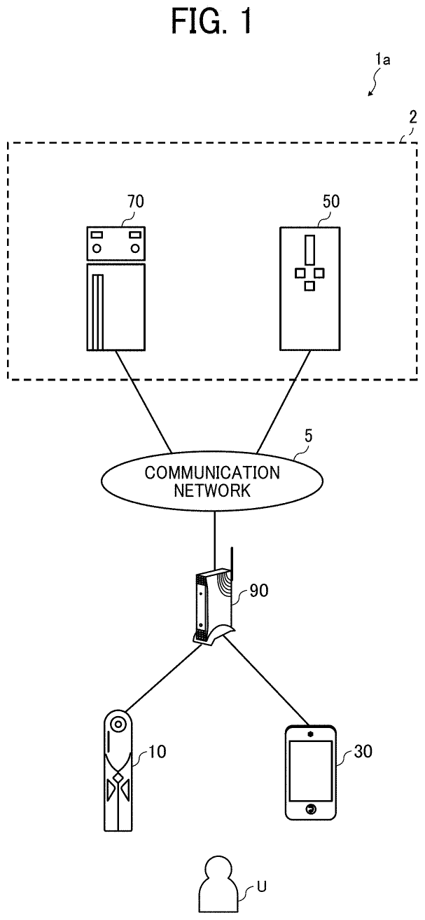

A system configuration of a communication system 1a of the first embodiment will first be described with FIG. 1.

FIG. 1 is a diagram illustrating an exemplary system configuration of the communication system 1a of the first embodiment. The communication system 1a illustrated in FIG. 1 is a system that uploads an image captured by an image capturing apparatus 10 to a content distribution system 50 to enable content distribution via a communication network 5.

The communication system 1a includes the image capturing apparatus 10, a communication terminal 30, the content distribution system 50, a client program distribution system 70, and a router 90. The content distribution system 50, the client program distribution system 70, and the router 90 are communicably connected to each other via the communication network 5. The communication network 5 is implemented by the Internet, a mobile communication network, or a local area network (LAN), for example. The communication network 5 may include, as well as a wired communication network, a wireless communication network conforming to a standard such as third generation (3G), fourth generation (4G), fifth generation (5G), worldwide interoperability for microwave access (WiMAX) or long term evolution (LTE), for example.

The image capturing apparatus 10 is a digital camera capable of capturing the image of a subject to acquire a captured image of the subject. For example, the image capturing apparatus 10 is a special digital camera for obtaining a 360-degree omnidirectional panoramic image. The image capturing apparatus 10 may be a typical digital camera (e.g., a single-lens reflex camera or a compact digital camera). If the communication terminal 30 is equipped with a camera, the communication terminal 30 may serve as a digital camera. It is assumed in the following description of the present embodiment that the image capturing apparatus 10 is a digital camera for obtaining the omnidirectional panoramic image (i.e., a later-described special image capturing apparatus). The image capturing apparatus 10 accesses the communication network 5 such as the Internet via the router 90 to upload the captured image to the content distribution system 50. The captured image may be a video image or a still image, or may include both the video image and the still image. Further, the captured image may be accompanied by sound.

The communication terminal 30 is a terminal apparatus used by a user U, such as a smartphone. The communication terminal 30 accesses the communication network 5 such as the Internet via the router 90 to communicate data with the content distribution system 50 and the client program distribution system 70. Further, the communication terminal 30 is connected to the image capturing apparatus 10 via a cable conforming to a standard such as universal serial bus (USB) or high-definition multimedia interface (HDMI). Alternatively, the image capturing apparatus 10 and the communication terminal 30 may wirelessly communicate with each other, without the cable, with a near field wireless communication technology conforming to a standard such as Bluetooth (registered trademark) or near field communication (NFC), for example. The communication terminal 30 is not limited to the smartphone, and may be a tablet terminal, a mobile phone, or a personal computer (PC), for example.

The content distribution system 50 is a system that provides a content distribution service to the user U via the communication network 5 such as the Internet. The term “content” refers to an image such as a video image or a still image, music, a world wide web (Web) site, an application (i.e., an application program), or a text file, for example. The content distribution service may be YouTube (registered trademark), Instagram (registered trademark), or Twitter (registered trademark), for example. The content distribution system 50 distributes the image uploaded from the image capturing apparatus 10 to the user U via the Internet, for example.

The client program distribution system 70 is a system that distributes a program for using the content distribution service with the image capturing apparatus 10. The client program distribution system 70 transmits a client program to the image capturing apparatus 10 via the content distribution system 50.

Herein, the content distribution system 50 and the client program distribution system 70 are provided for each content distribution service. That is, the communication system 1a may include a plurality of pairs of the content distribution system 50 and the client program distribution system 70.

The content distribution system 50 may be implemented by a single computer, or may be implemented by a plurality of computers to which units (e.g., functions, devices, and memories) of the content distribution system 50 are divided and allocated as desired. The same is true of the client program distribution system 70. The content distribution system 50 and the client program distribution system 70 form a service providing system 2. The service providing system 2 may be implemented by a single computer including units (e.g., functions and devices) of the content distribution system 50 and the client program distribution system 70.

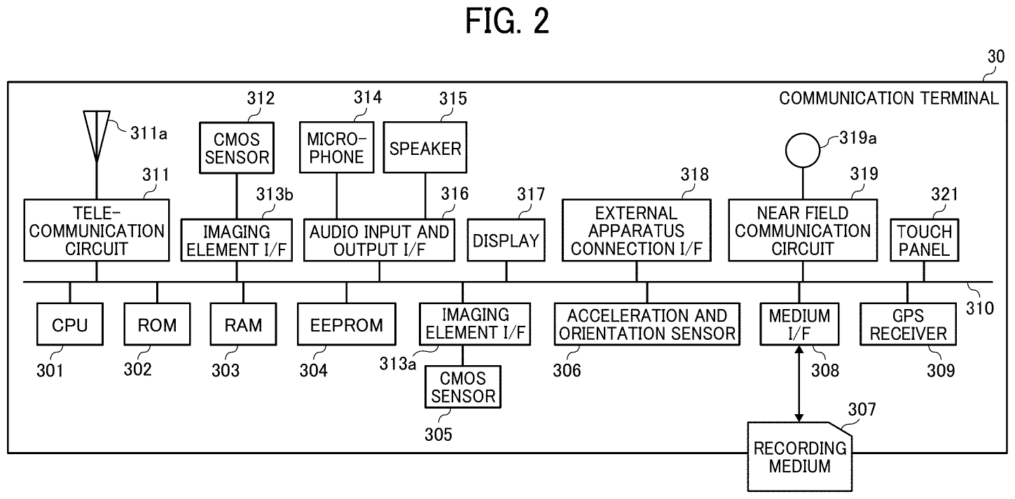

Respective hardware configurations of apparatuses and terminal forming the communication system 1a will be described with FIGS. 2 to 4. A component may be added to or deleted from each of hardware configurations illustrated in FIGS. 2 to 4.

A hardware configuration of the communication terminal 30 will be described with FIG. 2.

FIG. 2 is a diagram illustrating an exemplary hardware configuration of the communication terminal 30 of the first embodiment. The communication terminal 30 includes a central processing unit (CPU) 301, a read only memory (ROM) 302, a random access memory (RAM) 303, an electrically erasable programmable ROM (EEPROM) 304, a complementary metal oxide semiconductor (CMOS) sensor 305, an imaging element interface (I/F) 313a, an acceleration and orientation sensor 306, a medium I/F 308, and a global positioning system (GPS) receiver 309.

The CPU 301 controls an overall operation of the communication terminal 30. The ROM 302 stores a program used to drive the CPU 301 such as an initial program loader (IPL). The RAM 303 is used as a work area for the CPU 301. The EEPROM 304 performs reading or writing of various data of a program for the communication terminal 30, for example, under the control of the CPU 301.

The CMOS sensor 305 captures the image of a subject (normally the image of the user) under the control of the CPU 301 to obtain image data. The imaging element I/F 313a is a circuit that controls the driving of the CMOS sensor 305. The acceleration and orientation sensor 306 includes various sensors such as an electromagnetic compass that detects geomagnetism, a gyrocompass, and an acceleration sensor. The medium I/F 308 controls writing (i.e., storage) and reading of data to and from a recording medium 307 such as a flash memory. The GPS receiver 309 receives a GPS signal from a GPS satellite.

The communication terminal 30 further includes a telecommunication circuit 311, an antenna 311a, a CMOS sensor 312, an imaging element I/F 313b, a microphone 314, a speaker 315, an audio input and output I/F 316, a display 317, an external apparatus connection I/F 318, a near field communication circuit 319, an antenna 319a for the near field communication circuit 319, a touch panel 321, and a bus line 310.

The telecommunication circuit 311 is a circuit that communicates with another apparatus via the communication network 5. The CMOS sensor 312 is a built-in imaging device capable of capturing the image of a subject under the control of the CPU 301 to obtain image data. The imaging element I/F 313b is a circuit that controls the driving of the CMOS sensor 312. The microphone 314 is a built-in sound collecting device for inputting sound. The audio input and output I/F 316 is a circuit that processes input of audio signals from the microphone 314 and output of audio signals to the speaker 315 under the control of the CPU 301.

The display 317 is implemented as a liquid crystal or organic electroluminescence (EL) display, for example, that displays the image of the subject and various icons, for example. The external apparatus connection I/F 318 is an interface for connecting the communication terminal 30 to various external apparatuses. The near field communication circuit 319 is a communication circuit conforming to a standard such as NFC or Bluetooth. The touch panel 321 is an input device for the user to operate the communication terminal 30 by pressing the display 317. The bus line 310 includes an address bus and a data bus for electrically connecting the CPU 301 and the other components.

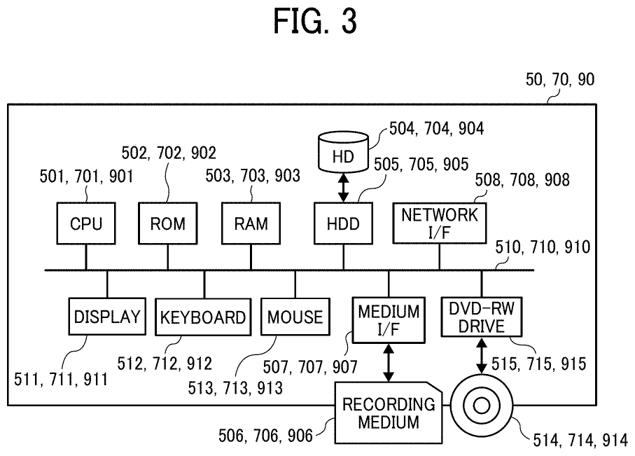

A hardware configuration of each of the content distribution system 50, the client program distribution system 70, and the router 90 will be described with FIG. 3.

FIG. 3 is a diagram illustrating an exemplary hardware configuration of each of the content distribution system 50, the client program distribution system 70, and the router 90 of the first embodiment. Each of the content distribution system 50, the client program distribution system 70, and the router 90 is implemented by a typical computer. A computer as an example of the content distribution system 50 includes a CPU 501, a ROM 502, a RAM 503, a hard disk (HD) 504, a hard disk drive (HDD) 505, a medium I/F 507, a network I/F 508, a display 511, a keyboard 512, a mouse 513, a digital versatile disk rewritable (DVD-RW) drive 515, and a bus line 510.

The CPU 501 controls an overall operation of the content distribution system 50. The ROM 502 stores a program used to drive the CPU 501. The RAM 503 is used as a work area for the CPU 501. The HDD 505 controls writing and reading of various data to and from the HD 504 under the control of the CPU 501. The HD 504 stores various data of a program, for example. The medium I/F 507 controls writing (i.e., storage) and reading of data to and from a recording medium 506 such as a flash memory.

The network I/F 508 is an interface for performing data communication via the communication network 5. The display 511 displays various information such as a cursor, menus, windows, text, and images. The keyboard 512 is an input device including a plurality of keys for inputting text, numerical values, and various instructions, for example. The mouse 513 is an input device used to select and execute various instructions, select a processing target, and move the cursor, for example. The DVD-RW drive 515 controls reading of various data from a DVD-RW 514 as an example of a removable recording medium. The DVD-RW 514 may be replaced by a DVD-recordable (DVD-R), for example. Further, the DVD-RW drive 515 may be a Blu-ray (registered trademark) drive or a compact disc (CD)-RW drive, for example, for controlling writing (i.e., storage) and reading of data to and from a disc such as a Blu-ray disc rewritable (BD-RE) or a CD-RW. The bus line 510 includes an address bus and a data bus for electrically connecting the CPU 501 and the other components illustrated in FIG. 3.

The client program distribution system 70, which is implemented by a typical computer, includes a CPU 701, a ROM 702, a RAM 703, an HD 704, an HDD 705, a medium I/F 707, a network I/F 708, a display 711, a keyboard 712, a mouse 713, a DVD-RW drive 715, and a bus line 710, as illustrated in FIG. 3. These components are similar in configuration to the CPU 501, the ROM 502, the RAM 503, the HD 504, the HDD 505, the medium I/F 507, the network I/F 508, the display 511, the keyboard 512, the mouse 513, the DVD-RW drive 515, and the bus line 510 of the content distribution system 50, and thus description thereof will be omitted. In the client program distribution system 70, the HD 704 stores a program for the client program distribution system 70.

The router 90, which is implemented by a typical computer, includes a CPU 901, a ROM 902, a RAM 903, an HD 904, an HDD 905, a medium I/F 907, a network I/F 908, a display 911, a keyboard 912, a mouse 913, a DVD-RW drive 915, and a bus line 910, as illustrated in FIG. 3. These components are similar in configuration to the CPU 501, the ROM 502, the RAM 503, the HD 504, the HDD 505, the medium I/F 507, the network I/F 508, the display 511, the keyboard 512, the mouse 513, the DVD-RW drive 515, and the bus line 510 of the content distribution system 50, and thus description thereof will be omitted. In the router 90, the HD 904 stores a program for the router 90.

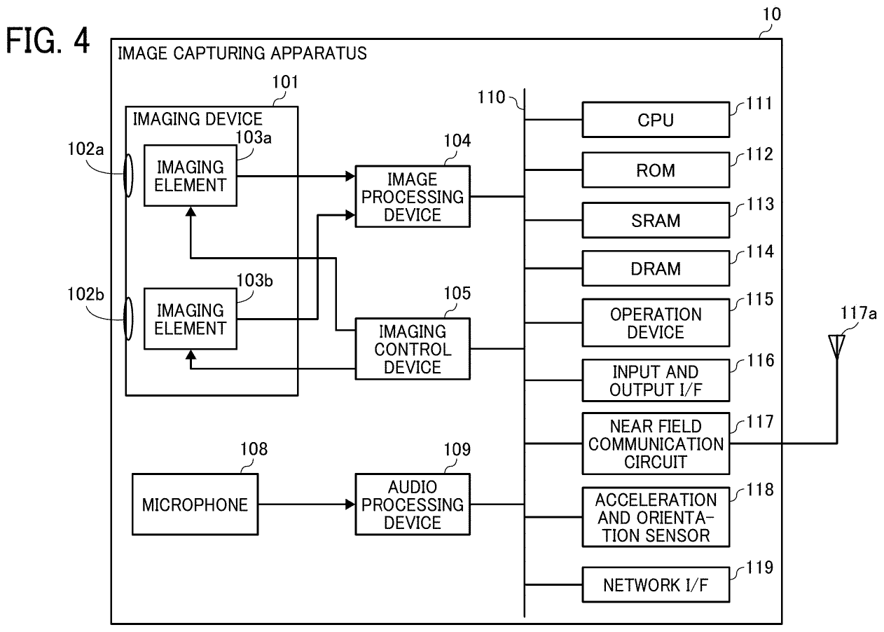

A hardware configuration of the image capturing apparatus 10 will be described with FIG. 4.

FIG. 4 is a diagram illustrating an exemplary hardware configuration of the image capturing apparatus 10 of the first embodiment. In the present example, the image capturing apparatus 10 is an omnidirectional (i.e., all-directional) image capturing apparatus with two imaging elements. However, the number of imaging elements included in the image capturing apparatus 10 may be three or more. Further, the image capturing apparatus 10 is not necessarily required to be an apparatus dedicated to the purpose of capturing the all-directional image. Therefore, an all-directional imaging device may be additionally attached to a regular digital camera or smartphone, for example, to provide substantially the same function as the function of an omnidirectional image capturing apparatus.

As illustrated in FIG. 4, the image capturing apparatus 10 includes an imaging device 101, an image processing device 104, an imaging control device 105, a microphone 108, an audio processing device 109, a CPU 111, a ROM 112, a static RAM (SRAM) 113, a dynamic RAM (DRAM) 114, an operation device 115, an input and output I/F 116, a near field communication circuit 117, an antenna 117a for the near field communication circuit 117, an acceleration and orientation sensor 118, and a network I/F 119.

The imaging device 101 includes two wide-angle (i.e., fisheye) lenses 102a and 102b (hereinafter referred to as the lenses 102 where distinction therebetween is unnecessary) and two imaging elements 103a and 103b corresponding thereto. Each of the lenses 102 has an angle of view of at least 180 degrees to form a hemispherical image. The lenses 102 are an example of an optical imaging system. Each of the imaging elements 103a and 103b includes an image sensor, a timing signal generating circuit, and a group of registers, for example. The image sensor may be a CMOS or charge coupled device (CCD) sensor that converts an optical image formed by the lens 102a or 102b into image data in the form of electrical signals and outputs the image data. The timing signal generating circuit generates a horizontal or vertical synchronization signal or a pixel clock signal for the image sensor. Various commands and parameters for the operation of the imaging element 103a or 103b are set in the group of registers.

Each of the imaging elements 103a and 103b of the imaging device 101 is connected to the image processing device 104 via a parallel I/F bus, and is connected to the imaging control device 105 via a serial I/F bus (e.g., an inter-integrated circuit (I²C) bus). The image processing device 104, the imaging control device 105, and the audio processing device 109 are connected to the CPU 111 via a bus 110. The bus 110 is further connected to the ROM 112, the SRAM 113, the DRAM 114, the operation device 115, the input and output I/F 116, the near field communication circuit 117, the acceleration and orientation sensor 118, and the network I/F 119, for example.

The image processing device 104 receives image data items from the imaging elements 103a and 103b via the parallel I/F bus, performs a predetermined process on the image data items, and combines the processed image data items to generate the data of a later-described equirectangular projection image.

The imaging control device 105 sets commands in the groups of registers of the imaging elements 103a and 103b via the serial I/F bus such as the I²C bus, with the imaging control device 105 and the imaging elements 103a and 103b normally acting as a master device and slave devices, respectively. The imaging control device 105 receives the commands from the CPU 111. The imaging control device 105 further receives data such as status data from the groups of registers in the imaging elements 103a and 103b via the serial I/F bus such as the I²C bus, and transmits the received data to the CPU 111.

The imaging control device 105 further instructs the imaging elements 103a and 103b to output the image data when a shutter button of the operation device 115 is pressed down. The image capturing apparatus 10 may have a preview display function or a video display function using a display (e.g., a display of a smartphone). In this case, the imaging elements 103a and 103b continuously output the image data at a predetermined frame rate. The frame rate is defined as the number of frames per minute.

The imaging control device 105 also functions as a synchronization controller that cooperates with the CPU 111 to synchronize the image data output time between the imaging elements 103a and 103b. In the present embodiment, the image capturing apparatus 10 is not equipped with a display. The image capturing apparatus 10, however, may be equipped with a display.

The microphone 108 converts sound into audio (signal) data. The audio processing device 109 receives the audio data from the microphone 108 via an I/F bus, and performs a predetermined process on the audio data.

The CPU 111 controls an overall operation of the image capturing apparatus 10, and executes various processes. The ROM 112 stores various programs for the CPU 111. The SRAM 113 and the DRAM 114, which are used as work memories, store programs executed by the CPU 111 and data being processed. The DRAM 114 particularly stores image data being processed in the image processing device 104 and processed data of the equirectangular projection image.

The operation device 115 collectively refers to operation buttons including the shutter button. The user operates the operation device 115 to input various image capture modes and image capture conditions, for example.

The input and output I/F 116 collectively refers to interface circuits (e.g., a USB I/F circuit) connectable to an external recording medium (e.g., a secure digital (SD) card) and a PC, for example. The input and output I/F 116 may be a wireless or wired interface. Via the input and output I/F 116, the data of the equirectangular projection image stored in the DRAM 114 may be recorded on an external recording medium, or may be transmitted as necessary to an external terminal (apparatus).

The near field communication circuit 117 communicates with the external terminal (apparatus) via the antenna 117a of the image capturing apparatus 10 in accordance with a near field wireless communication technology conforming to a standard such as NFC or Bluetooth. The near field communication circuit 117 is capable of transmitting the data of the equirectangular projection image to the external terminal (apparatus).

The acceleration and orientation sensor 118 calculates the orientation of the image capturing apparatus 10 from the geomagnetism, and outputs orientation information. The orientation information is an example of related information (i.e., metadata) conforming to the exchangeable image file format (Exif) standard. The orientation information is used in image processing such as image correction of the captured image. The related information includes data such as the date and time of capturing the image and the data capacity of the image data. The acceleration and orientation sensor 118 also detects changes in angles (i.e., the roll angle, the pitch angle, and the yaw angle) of the image capturing apparatus 10 accompanying the movement of the image capturing apparatus 10. The changes in the angles are an example of the related information (i.e., metadata) conforming to the Exif standard, and are used in image processing such as image correction of the captured image. The acceleration and orientation sensor 118 further detects the respective accelerations in three axial directions. The image capturing apparatus 10 calculates the attitude thereof (i.e., the angle of the image capturing apparatus 10 relative to the gravitational direction) based on the accelerations detected by the acceleration and orientation sensor 118. Equipped with the acceleration and orientation sensor 118, the image capturing apparatus 10 is improved in the accuracy of image correction.

The network I/F 119 is an interface for performing data communication using the communication network 5 such as the Internet via the router 90.

Each of the above-described programs may be distributed as recorded on a computer readable recording medium in an installable or executable file format. Examples of the recording medium include a CD-R, a DVD, a Blu-ray disc, and an SD card. The recording medium may be shipped to the market as a program product. For example, the image capturing apparatus 10 executes a program according to an embodiment of the present invention to implement a data distribution method according to an embodiment of the present invention.

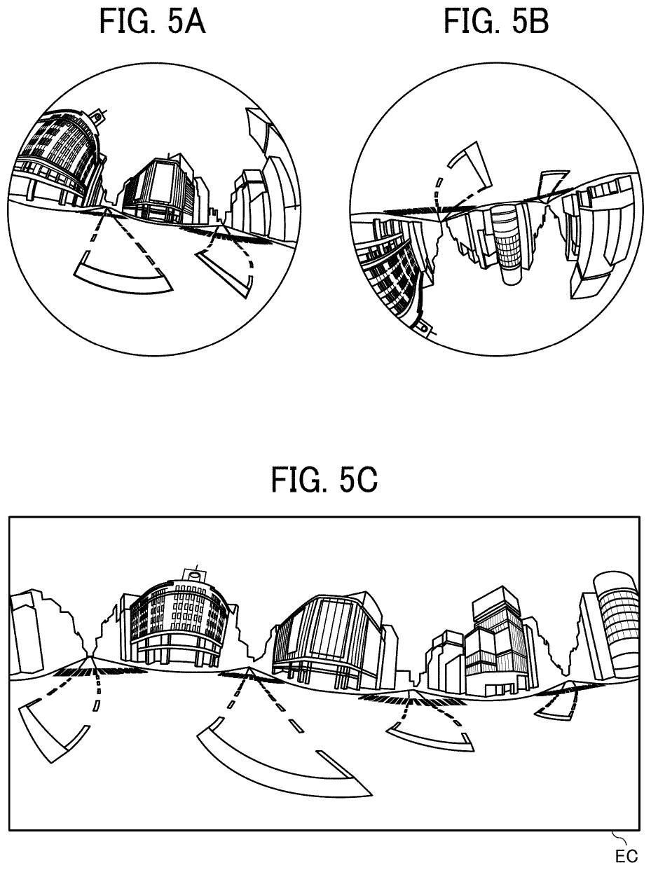

An example of the omnidirectional image acquired by a special image capturing apparatus will be described with FIGS. 5A, 5B, and 5C to FIG. 9. The special image capturing apparatus is an example of the image capturing apparatus 10.

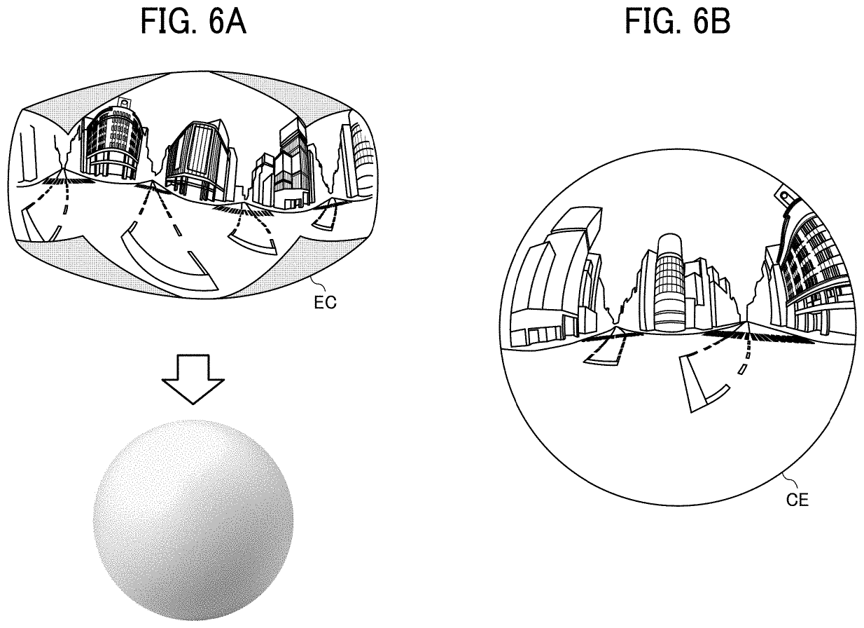

With FIGS. 5A, 5B, and 5C and FIGS. 6A and 6B, a description will first be given of an overview of a process of generating an equirectangular projection image EC from images captured by the special image capturing apparatus and then generating an omnidirectional image CE from the equirectangular projection image EC.

FIG. 5A is a diagram illustrating a front hemispherical image captured by the special image capturing apparatus. FIG. 5B is a diagram illustrating a rear hemispherical image captured by the special image capturing apparatus. FIG. 5C is a diagram illustrating an image generated from the hemispherical images by equirectangular projection (hereinafter referred to as the equirectangular projection image EC). FIG. 6A is a conceptual diagram illustrating the equirectangular projection image EC covering a sphere. FIG. 6B is a diagram illustrating the omnidirectional image CE obtained from the equirectangular projection image EC.

As illustrated in FIG. 5A, the front hemispherical image, which is obtained by the imaging element 103a, is distorted by the lens 102a. Further, as illustrated in FIG. 5B, the rear hemispherical image, which is obtained by the imaging element 103b, is distorted by the lens 102b. The special image capturing apparatus combines the front hemispherical image and the rear hemispherical image rotated therefrom by 180 degrees, to thereby generate the equirectangular projection image EC as illustrated in FIG. 5C.

Then, with an application programming interface (API) such as open graphics library for embedded systems (OpenGL ES, registered trademark), the special image capturing apparatus places the equirectangular projection image EC on the surface of a sphere to cover the spherical surface, as illustrated in FIG. 6A. Thereby, the omnidirectional image CE as illustrated in FIG. 6B is generated. The omnidirectional image CE is thus expressed as the equirectangular projection image EC facing the center of the sphere. OpenGL ES is a graphics library used to visualize two-dimensional (2D) or three-dimensional (3D) data. The omnidirectional image CE may be a still or video image.

As described above, the omnidirectional image CE is an image placed on a sphere to cover the spherical surface, and thus is perceived as unnatural to human eyes. Therefore, the special image capturing apparatus controls a particular display to display a part of the omnidirectional image CE as a planar image with less distortion so that the displayed image is perceived as natural to human eyes. Hereinafter, the above-described part of the omnidirectional image CE will be described as the viewable area, and the image of the viewable area will be described as the viewable area image.

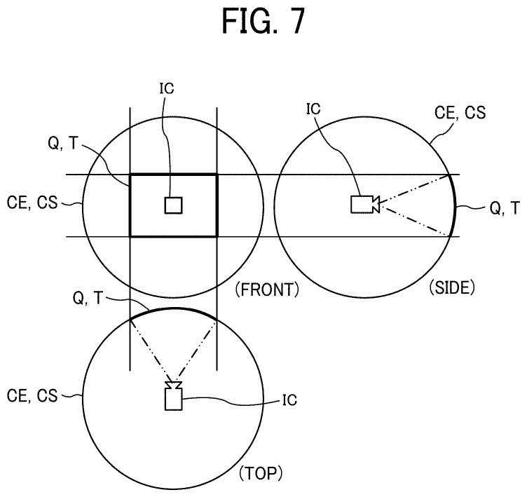

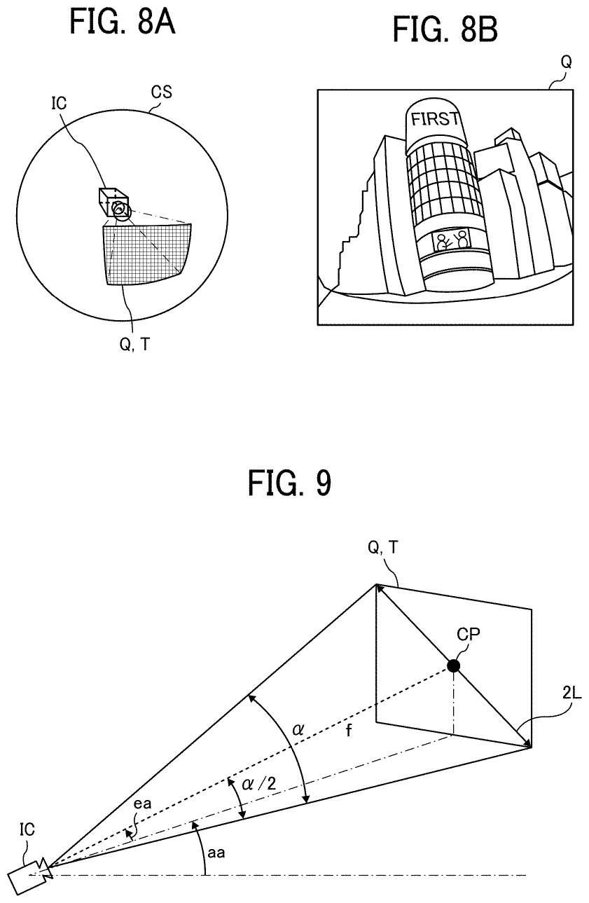

Display of the viewable area image will be described with FIG. 7 and FIGS. 8A and 8B.

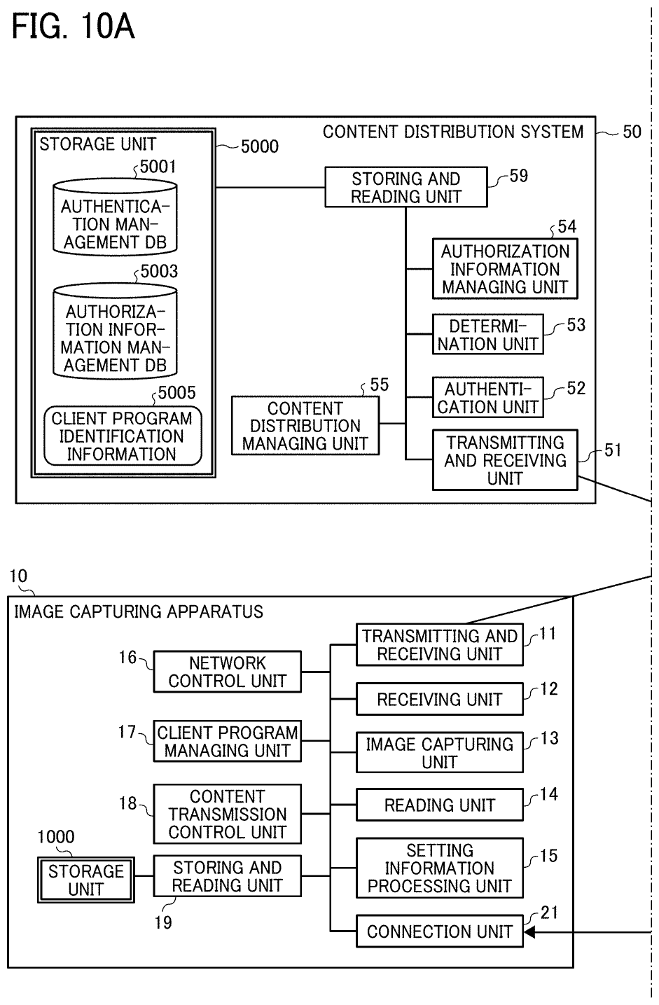

FIG. 7 is a diagram illustrating the respective positions of a virtual camera IC and a viewable area T when the omnidirectional image CE is expressed as a three-dimensional solid sphere CS. The position of the virtual camera IC corresponds to the position of the viewpoint of the user viewing the omnidirectional image CE expressed as the three-dimensional solid sphere CS, i.e., the position of the user's viewpoint relative to the omnidirectional image CE. FIG. 8A is a perspective view of the omnidirectional image CE in FIG. 7 expressed as the solid sphere CS. FIG. 8B is a diagram illustrating a viewable area image Q displayed on a display. In FIG. 8A, the omnidirectional image CE in FIG. 7 is illustrated as the three-dimensional solid sphere CS. When the omnidirectional image CE generated as described above is expressed as the solid sphere CS, the virtual camera IC is located inside the omnidirectional image CE, as illustrated in FIG. 7. The viewable area T of the omnidirectional image CE corresponds to an image capturing area of the virtual camera IC, and is identified by viewable area information. The viewable area information represents the image capturing direction and the angle of view of the virtual camera IC in a three-dimensional virtual space including the omnidirectional image CE. The viewable area T may be zoomed in or out with the virtual camera IC moved toward or away from the omnidirectional image CE. The viewable area image Q is the image of the viewable area T of the omnidirectional image CE. The viewable area T is therefore identified with an angle of view a of the virtual camera IC and a distance f from the virtual camera IC to the omnidirectional image CE (see FIG. 9).

As illustrated in FIG. 8B, the viewable area image Q illustrated in FIG. 8A is displayed on a particular display as the image of the image capturing area of the virtual camera IC. FIG. 8B illustrates the viewable area image Q represented by initially set (i.e., default) viewable area information. In the following description of the viewable area T, the image capturing direction (ea, aa) and the angle of view a of the virtual camera IC will be used. The viewable area T, however, may be expressed not with the angle of view a and the distance f but with the image capturing area (X, Y, Z) of the virtual camera IC corresponding to the viewable area T.

The relationship between the viewable area information and the image of the viewable area T will be described with FIG. 9.

FIG. 9 is a diagram illustrating the relationship between the viewable area information and the image of the viewable area T. As illustrated in FIG. 9, ea represents the elevation angle, and aa represents the azimuth angle. Further, a represents the angle of view. That is, the attitude of the virtual camera IC is changed such that the point of interest of the virtual camera IC represented by the image capturing direction (ea, aa) corresponds to a center point CP of the viewable area T as the image capturing area of the virtual camera IC. As illustrated in FIG. 9, when the diagonal angle of view of the viewable area T is expressed as the angle of view a of the virtual camera IC, the center point CP corresponds to (x, y) parameters of the viewable area information. The viewable area image Q is the image of the viewable area T of the omnidirectional image CE in FIG. 7. Further, f represents the distance from the virtual camera IC to the center point CP, and L represents the distance between a given vertex of the viewable area T and the center point CP. Thus, 2L represents the length of a diagonal of the viewable area T. Further, in FIG. 9, a trigonometric function typically expressed as equation (1) given below holds.

[Math. 1]

L/f=tan(α/2) (1)

The above-described special image capturing apparatus is an example of an image capturing apparatus capable of acquiring a wide-angle image. The omnidirectional image is an example of the wide-angle image. The wide-angle image is typically captured with a wide-angle lens capable of capturing an image in a range wider than the viewing range of the human eye. Further, the wide-angle image normally refers to the image captured with a lens having a focal length of 35 mm or less in 35 mm film equivalent.

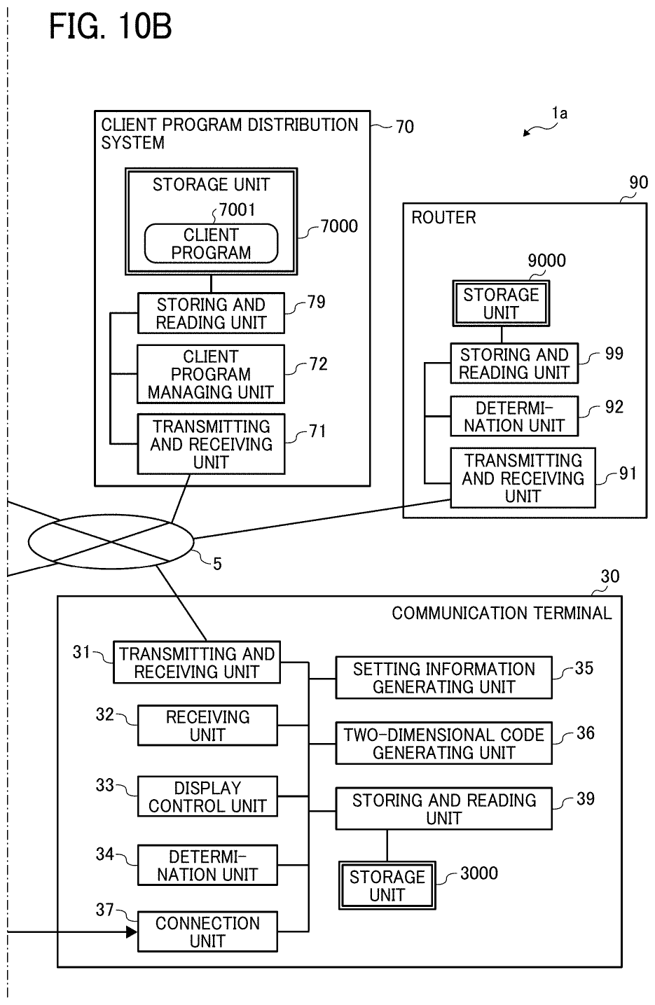

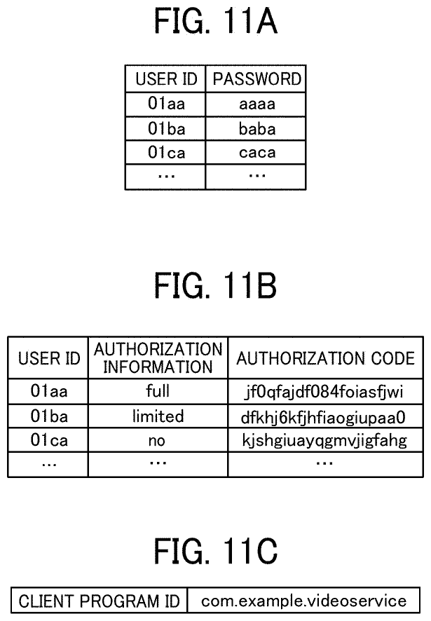

A functional configuration of the communication system 1a of the first embodiment will be described with FIGS. 10A and 10B and FIGS. 11A, 11B, and 11C.

FIGS. 10A and 10B are diagrams illustrating an exemplary functional configuration of the communication system 1a of the first embodiment. FIGS. 10A and 10B illustrate parts of the terminal and apparatuses in FIG. 1 related to later-described processes and operations.

A functional configuration of the image capturing apparatus 10 will first be described with FIG. 10A.

The image capturing apparatus 10 includes a transmitting and receiving unit 11, a receiving unit 12, an image capturing unit 13, a reading unit 14, a setting information processing unit 15, a network control unit 16, a client program managing unit 17, a content transmission control unit 18, a storing and reading unit 19, and a connection unit 21. Each of these units is a function or functional unit implemented when at least one of the components illustrated in FIG. 4 operates in response to a command from the CPU 111 in accordance with a program deployed on the DRAM 114. The image capturing apparatus 10 further includes a storage unit 1000 implemented by the ROM 112 illustrated in FIG. 4.

The transmitting and receiving unit 11 is a function implemented by a command from the CPU 111 and the network I/F 119 in FIG. 4 to transmit and receive various data and information to and from another apparatus via the router 90. For example, the transmitting and receiving unit 11 transmits the captured image acquired by the image capturing unit 13 to the content distribution system 50.

The receiving unit 12 is a function implemented by a command from the CPU 111 and the operation device 115 in FIG. 4 to receive an operation input by the user.

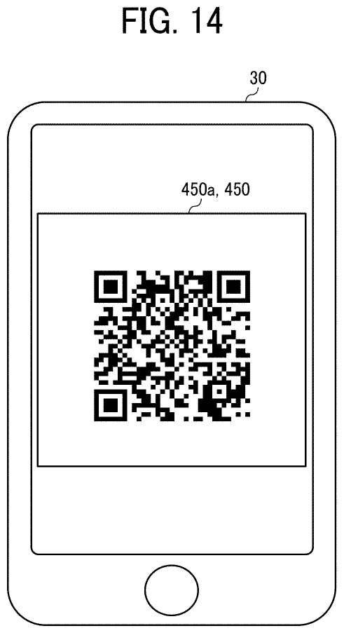

The image capturing unit 13 is a function implemented by a command from the CPU 111, the imaging device 101, the image processing device 104, the imaging control device 105, the microphone 108, and the audio processing device 109 in FIG. 4 to capture the image of the subject (e.g., an object or surroundings) and acquire the captured image. The captured image acquired by the image capturing unit 13 may be a video image or a still image. Further, the captured image may be accompanied by sound. The image capturing unit 13 captures the image of a two-dimensional code displayed on the display 317 of the communication terminal 30 (see FIG. 14), for example.

The reading unit 14 is a function implemented by a command from the CPU 111 and devices such as the image processing device 104 in FIG. 4 to read the two-dimensional code in the captured image acquired by the image capturing unit 13.

The setting information processing unit 15 is a function implemented by a command from the CPU 111 in FIG. 4 to acquire setting information for using the content distribution service with the two-dimensional code read by the reading unit 14.

The network control unit 16 is a function implemented by a command from the CPU 111 and the network I/F 119 in FIG. 4 to control the connection to the communication network 5 such as the Internet. For example, the network control unit 16 accesses the router 90 to connect to the communication network 5.

The client program managing unit 17 is a function implemented by a command from the CPU 111 in FIG. 4 to manage the client program executed by the image capturing apparatus 10. For example, the client program managing unit 17 manages the client program installed for each available content distribution service.

The content transmission control unit 18 is a function implemented by a command from the CPU 111 in FIG. 4 to control the transmission of content to the content distribution system 50. For example, the content transmission control unit 18 transmits the captured image acquired by the image capturing unit 13 to the content distribution system 50.

The connection unit 21 is a function implemented by a command from the CPU 111 and the input and output I/F 116 or the near field communication circuit 117 in FIG. 4 to receive power supply from the communication terminal 30 and perform data communication.

The storing and reading unit 19 is a function implemented by a command from the CPU 111 in FIG. 4 to store various data in the storage unit 1000 or read various data therefrom. The storage unit 1000 also stores the data of the captured image acquired by the image capturing unit 13. The data of the captured image stored in the storage unit 1000 may be deleted from the storage unit 1000 after a predetermined time has elapsed since the acquisition of the data of the captured image by the image capturing unit 13 or after the data of the captured image has been transmitted to the content distribution system 50.

A functional configuration of the communication terminal 30 will be described with FIG. 10B.

The communication terminal 30 includes a transmitting and receiving unit 31, a receiving unit 32, a display control unit 33, a determination unit 34, a setting information generating unit 35, a two-dimensional code generating unit 36, a connection unit 37, and a storing and reading unit 39. Each of these units is a function or functional unit implemented when at least one of the components illustrated in FIG. 2 operates in response to a command from the CPU 301 in accordance with a program deployed on the RAM 303. The communication terminal 30 further includes a storage unit 3000 implemented by the ROM 302 or the recording medium 307 illustrated in FIG. 2.

The transmitting and receiving unit 31 is a function implemented by a command from the CPU 301 and the telecommunication circuit 311 in FIG. 2 to transmit and receive various data and information to and from another apparatus via the router 90.

The receiving unit 32 is a function implemented by a command from the CPU 301 and an input device such as the touch panel 321 in FIG. 2 to receive various selections and operations input to the communication terminal 30.

The display control unit 33 is a function implemented by a command from the CPU 301 in FIG. 2 to control the display 317 of the communication terminal 30 to display various screens. The display control unit 33 controls the display 317 to display the two-dimensional code generated by the two-dimensional code generating unit 36.

The determination unit 34 is a function implemented by a command from the CPU 301 in FIG. 2 to make various determinations.

The setting information generating unit 35 is a function implemented by a command from the CPU 301 in FIG. 2 to generate the setting information for using the content distribution service.

The two-dimensional code generating unit 36 is a function implemented by a command from the CPU 301 in FIG. 2 to generate the two-dimensional code with the setting information generated by the setting information generating unit 35. The two-dimensional code is a code such as a quick response (QR) code (registered trademark), DataMatrix (DataCode) (registered trademark), MaxiCode (registered trademark), or portable document format (PDF) 417, for example.

The connection unit 37 is a function implemented by a command from the CPU 301 and the external apparatus connection I/F 318 or the near field communication circuit 319 in FIG. 2 to supply power to the image capturing apparatus 10 and perform data communication.

The storing and reading unit 39 is a function implemented by a command from the CPU 301 in FIG. 2 to store various data in the storage unit 3000 or read various data therefrom.

A functional configuration of the content distribution system 50 will be described with FIG. 10A.

The content distribution system 50 includes a transmitting and receiving unit 51, an authentication unit 52, a determination unit 53, an authorization information managing unit 54, a content distribution managing unit 55, and a storing and reading unit 59. Each of these units is a function or functional unit implemented when at least one of the components illustrated in FIG. 3 operates in response to a command from the CPU 501 in accordance with a program deployed on the RAM 503. The content distribution system 50 further includes a storage unit 5000 implemented by the ROM 502, the HD 504, or the recording medium 506 illustrated in FIG. 3.

The transmitting and receiving unit 51 is a function implemented by a command from the CPU 501 and the network I/F 508 in FIG. 3 to transmit and receive various data and information to and from another apparatus via the communication network 5.

The authentication unit 52 is a function implemented by a command from the CPU 501 in FIG. 3 to perform an authentication process for an authentication request source apparatus based on a connection request received by the transmitting and receiving unit 51. For example, the authentication unit 52 performs a search through an authentication management database (DB) 5001 in the storage unit 5000 with a search key set to authorization information (i.e., a user identifier (ID) and a password) included in the connection request received by the transmitting and receiving unit 51. The authentication unit 52 then performs the authentication process for the authentication request source apparatus by determining whether the same user ID and password as those in the connection request are managed in the authentication management DB 5001.

The determination unit 53 is a function implemented by a command from the CPU 501 in FIG. 3 to make various determinations.

The authorization information managing unit 54 is a function implemented by a command from the CPU 501 in FIG. 3 to manage authorization information representing an access right to the content distribution service. For example, the authorization information managing unit 54 performs a search through an authorization information management DB 5003 in the storage unit 5000 with a search key set to the user ID included in the setting information received by the transmitting and receiving unit 51, to thereby identify an authorization code associated with the user ID.

The content distribution managing unit 55 is a function implemented by a command from the CPU 501 in FIG. 3 to manage the content distribution by the content distribution service.

The storing and reading unit 59 is a function implemented by a command from the CPU 501 in FIG. 3 to store various data in the storage unit 5000 or read various data therefrom. The storage unit 5000 also stores client program identification information (i.e., a client program ID) 5005 for identifying the client program provided by the client program distribution system 70 (see FIG. 11C). The client program identification information 5005 is an example of dedicated program identification information.

FIG. 11A is a conceptual diagram illustrating an authentication management table. The storage unit 5000 stores the authentication management DB 5001 configured as the authentication management table as illustrated in FIG. 11A. In the authentication management table, passwords are managed in association with user IDs for identifying users, which are managed by the content distribution system 50. For example, the authentication management table illustrated in FIG. 11A indicates that the user ID and the password of a user A are “01aa” and “aaaa,” respectively. In the example described below, the user ID is used in the settings for using the content distribution service. Alternatively, an apparatus ID (terminal ID) for identifying the image capturing apparatus 10 may be used in the settings for using the content distribution service. In this case, the apparatus IDs (terminal IDs) replace the user IDs in the authentication management table to be managed in association with the passwords.

FIG. 11B is a conceptual diagram illustrating an authorization information management table. The storage unit 5000 stores the authorization information management DB 5003 configured as the authorization information management table as illustrated in FIG. 11B. In the authorization information management table, the authorization information and the authorization code are managed in association with the corresponding user ID of the user managed in the content distribution service. The authorization information represents the access right to the content distribution service. For example, the authorization information management table illustrated in FIG. 11B indicates that the user A with the user ID “01aa” has a “full” access right to the content distribution service, and that a user B with a user ID “01ba” has a “limited” access right to the content distribution service, i.e., the user B has a limited range of accessibility to the content distribution service. The authorization information management table in FIG. 11B further indicates that a user C with a user ID “01ca” has “no” access right to the content distribution service.

A functional configuration of the client program distribution system 70 will be described with FIG. 10B.

The client program distribution system 70 includes a transmitting and receiving unit 71, a client program managing unit 72, and a storing and reading unit 79. Each of these units is a function or functional unit implemented when at least one of the components illustrated in FIG. 3 operates in response to a command from the CPU 701 in accordance with a program deployed on the RAM 703. The client program distribution system 70 further includes a storage unit 7000 implemented by the ROM 702, the HD 704, or a recording medium 706 illustrated in FIG. 3.

The transmitting and receiving unit 71 is a function implemented by a command from the CPU 701 and the network I/F 708 in FIG. 3 to transmit and receive various data and information to and from another apparatus via the communication network 5. For example, the transmitting and receiving unit 71 transmits a client program 7001 (an example of a dedicated program) stored in the storage unit 7000 to the content distribution system 50 in response to a request from the image capturing apparatus 10.

The client program managing unit 72 is a function implemented by a command from the CPU 701 in FIG. 3 to manage the client program 7001 for enabling the use of the content distribution service. The client program managing unit 72 accepts the registration of the client program 7001, and stores (i.e., registers) the client program 7001 in the storage unit 7000.

The storing and reading unit 79 is a function implemented by a command from the CPU 701 in FIG. 3 to store various data in the storage unit 7000 or read various data therefrom. The storage unit 7000 also stores the client program 7001 for enabling the image capturing apparatus 10 to use the content distribution service.

A functional configuration of the router 90 will be described with FIG. 10B.

The router 90 includes a transmitting and receiving unit 91, a determination unit 92, and a storing and reading unit 99. Each of these units is a function or functional unit implemented when at least one of the components illustrated in FIG. 3 operates in response to a command from the CPU 901 in accordance with a program deployed on the RAM 903. The router 90 further includes a storage unit 9000 implemented by the ROM 902, the HD 904, or a recording medium 906 illustrated in FIG. 3.

The transmitting and receiving unit 91 is a function implemented by a command from the CPU 901 and the network I/F 908 in FIG. 3 to transmit and receive various data and information to and from another apparatus via the communication network 5.

The determination unit 92 is a function implemented by a command from the CPU 901 in FIG. 3 to make various determinations. For example, in response to a request from the image capturing apparatus 10, the determination unit 92 determines whether the image capturing apparatus 10 is connectable to the communication network 5.

The storing and reading unit 99 is a function implemented by a command from the CPU 901 in FIG. 3 to store various data in the storage unit 9000 or read various data therefrom.

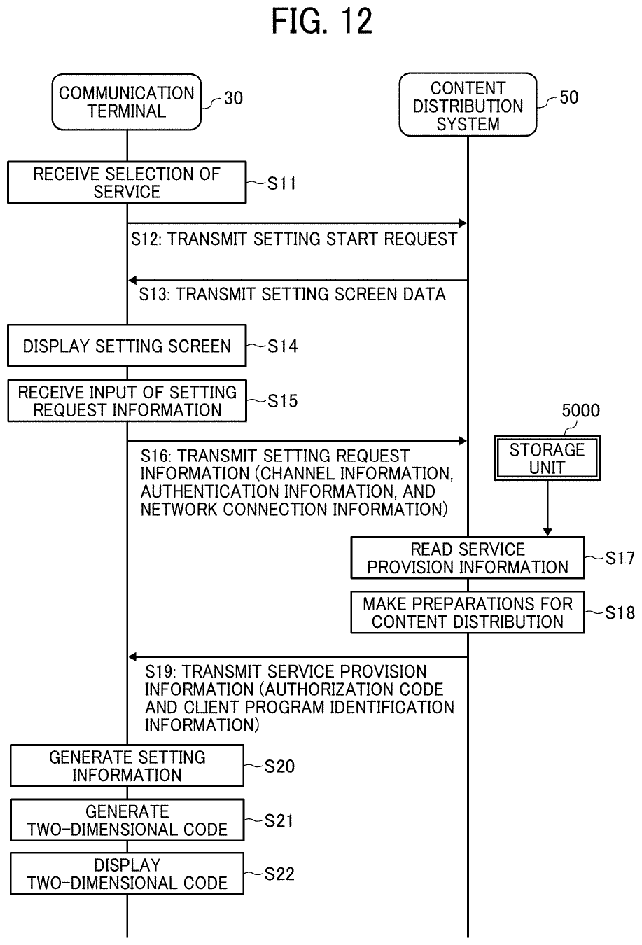

Processes and operations performed in the communication system 1a of the first embodiment will be described with FIGS. 12 to 21.

A description will first be given of a process of uploading content from the image capturing apparatus 10 to the content distribution system 50.

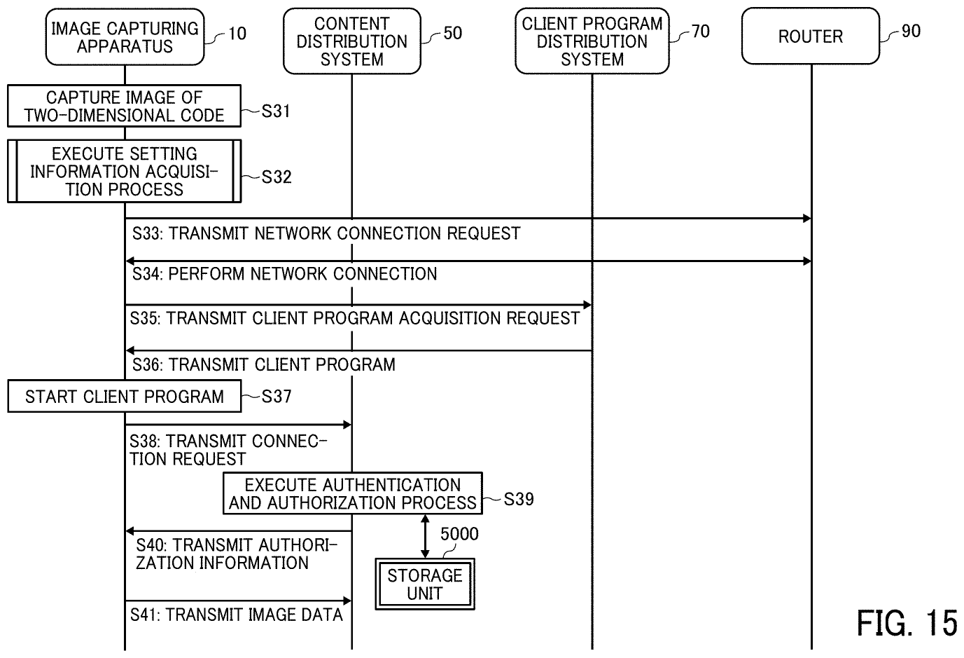

FIGS. 12 and 15 are sequence diagrams illustrating an exemplary content distribution process performed in the communication system 1a of the first embodiment. In response to receipt of a predetermined input operation performed by the user of the communication terminal 30, the receiving unit 32 of the communication terminal 30 receives a user selection of a content distribution service provided by the content distribution system 50 (step S11). Examples of the content distribution service, which distributes content such as a video image or an application, include YouTube, Instagram, and Twitter.

Then, the transmitting and receiving unit 31 of the communication terminal 30 transmits a setting start request to the content distribution system 50 (step S12). The setting start request requests settings for starting the use of the content distribution service. Then, the transmitting and receiving unit 51 of the content distribution system 50 receives the setting start request transmitted from the communication terminal 30. The transmitting and receiving unit 51 then transmits to the communication terminal 30 setting screen data to be used in the settings for starting the use of the content distribution service (step S13). Then, the transmitting and receiving unit 31 of the communication terminal 30 receives the setting screen data transmitted from the content distribution system 50.

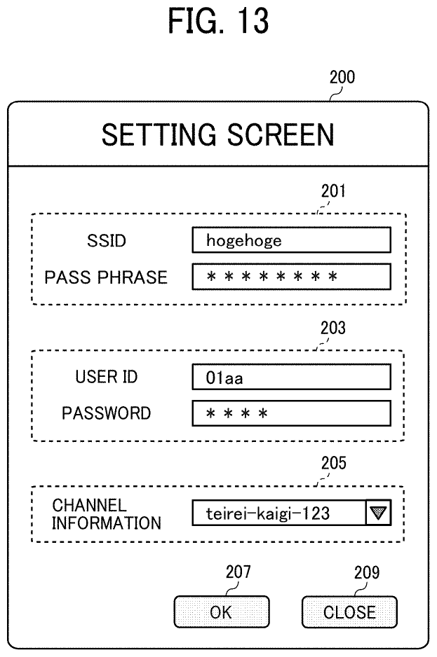

Then, the display control unit 33 of the communication terminal 30 controls the display 317 to display a setting screen 200 (see FIG. 13) based on the setting screen data received at step S13 (step S14).

The setting screen 200 displayed on the communication terminal 30 will be described with FIG. 13.

FIG. 13 is a diagram illustrating an example of the setting screen 200 displayed on the communication terminal 30 of the first embodiment. The setting screen 200 illustrated in FIG. 13 is displayed on the communication terminal 30 when the user performs setting to start using the content distribution service. The setting screen 200 includes a network connection information input field 201, an authentication information input field 203, a channel information input field 205, an OK button 207, and a CLOSE button 209. The network connection information input field 201 is used to input network connection information for connecting to the communication network 5. The authentication information input field 203 is used to input the user ID and the password, which are used in a user authentication process performed in the content distribution system 50. The channel information input field 205 is used to input information of the channel of the content distribution service. The OK button 207 is pressed to start the setting process. The CLOSE button 209 is pressed to cancel the setting process.

The network connection information includes the service set identifier (SSID) and the pass phrase of the router 90 for connecting to the communication network 5, for example. The channel information is information for identifying the distribution implemented on the content distribution service. The content distribution system 50 may implement multiple distributions on the same content distribution service, and thus distinguishes the respective distributions by channel. In the example described here, the channel information is input by the user. Alternatively, the channel information may be generated by the content distribution system 50 in accordance with the mode of use of the content distribution service. In this case, the channel information generated by the content distribution system 50 is included in later-described service provision information to be transmitted to the communication terminal 30.

The user may input information to each of the input fields by directly inputting the information with an input device such as the touch panel 321 or by selecting one of presented information items. The input fields may be displayed on separately displayed different setting screens. Further, information read from a recording medium connected to the communication terminal 30, such as a subscriber identity module (SIM) card or a secure digital (SD) card, may be input to the input fields.

In response to the data input to the input fields in the setting screen 200 by the user of the communication terminal 30, the receiving unit 32 of the communication terminal 30 receives input of setting request information (step S15). Then, the transmitting and receiving unit 31 of the communication terminal 30 transmits the setting request information received at step S15 to the content distribution system 50 (step S16). The setting request information includes the channel information for identifying the channel of the content distribution service to be used, the authentication information for the content distribution system 50 to use in the user authentication, and the network connection information to be used to connect to the communication network 5. Then, the transmitting and receiving unit 51 of the content distribution system 50 receives the setting request information transmitted from the communication terminal 30.

Then, the storing and reading unit 59 of the content distribution system 50 reads from the storage unit 5000 the service provision information for providing the content distribution service to the user (step S17). Specifically, the storing and reading unit 59 reads the client program identification information 5005 stored in the storage unit 5000. Further, the authorization information managing unit 54 performs a search through the authorization information management DB 5003 in the storage unit 5000 with the search key set to the user ID included in the setting request information received by the transmitting and receiving unit 51, for example, to thereby read the authorization code associated with the user ID. That is, the service provision information includes the client program identification information 5005 and the authorization code.

With the setting request information received at step S16 and the service provision information read at step S17, the content distribution managing unit 55 then makes preparations for the content distribution (step S18). Specifically, the content distribution managing unit 55 creates a virtual room or channel for the content distribution, for example.

Then, the transmitting and receiving unit 51 of the content distribution system 50 transmits the service provision information read at step S17 to the communication terminal 30 (step S19). Then, the transmitting and receiving unit 31 of the communication terminal 30 receives the service provision information transmitted from the content distribution system 50.

The setting information generating unit 35 of the communication terminal 30 then generates the setting information for using the content distribution service (step S20). The setting information includes the setting request information received at step S15 and the service provision information received at step S19.

Then, the two-dimensional code generating unit 36 generates the two-dimensional code with the setting information generated at step S20 (step S21). Then, the display control unit 33 controls the display 317 to display the two-dimensional code generated at step S21 (step S22).

The two-dimensional code displayed on the communication terminal 30 will be described with FIG. 14.

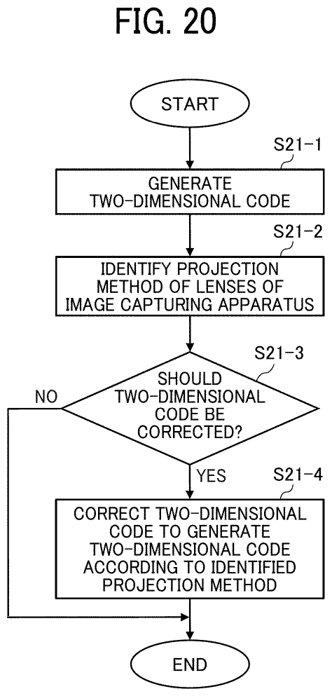

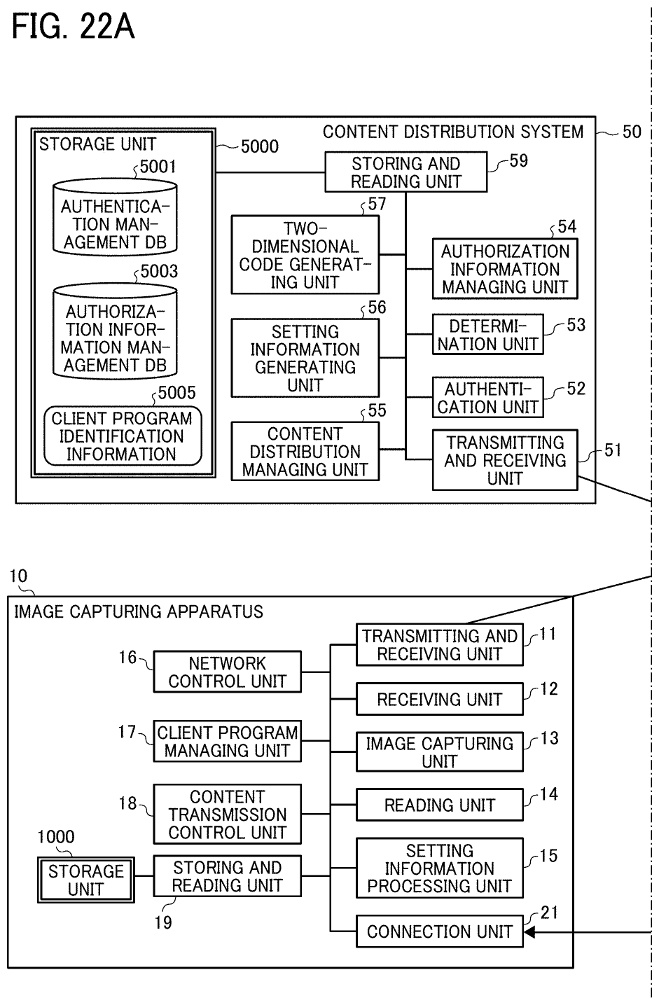

FIG. 14 is a diagram illustrating an example of the two-dimensional code displayed on the communication terminal 30 of the first embodiment. A two-dimensional code 450a illustrated in FIG. 14 is a QR code generated by the two-dimensional code generating unit 36. The setting information generated by the setting information generating unit 35 is embedded in the two-dimensional code 450a. Hereinafter, the two-dimensional code 450a and later-described two-dimensional codes 450b and 450c (see FIGS. 19 and 21) may each be referred to as the two-dimensional code 450 where distinction therebetween is unnecessary.

Then, as illustrated in FIG. 15, the image capturing unit 13 of the image capturing apparatus 10 captures the image of the two-dimensional code 450a displayed on the display 317 of the communication terminal 30 (step S31). Then, the image capturing apparatus 10 executes a setting information acquisition process with the two-dimensional code in the image captured at step S31 (step S32).

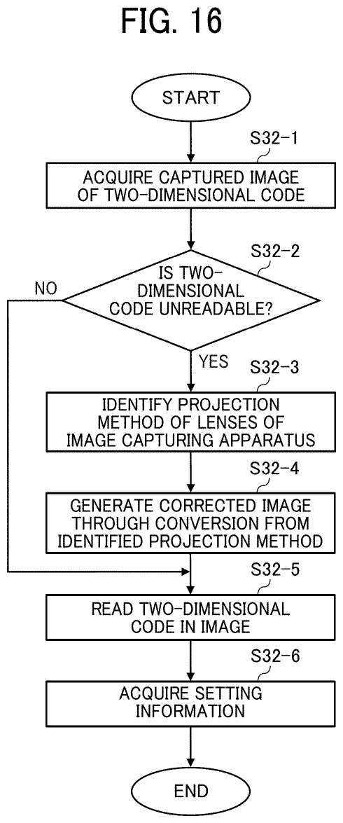

The setting information acquisition process will be described in detail with FIG. 16.

FIG. 16 is a flowchart illustrating an exemplary setting information acquisition process performed in the communication terminal 30 of the first embodiment.

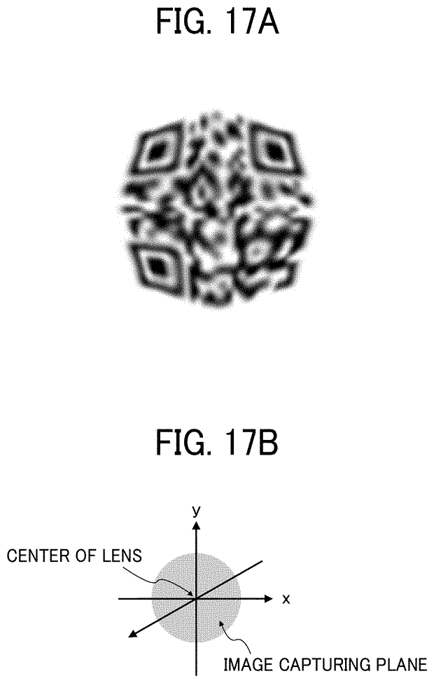

The image capturing unit 13 first acquires the captured image of the two-dimensional code 450a (step S32-1). Then, the reading unit 14 determines whether the two-dimensional code 450a in the acquired captured image is unreadable (step S32-2). Herein, the image capturing apparatus 10 is the special image capturing apparatus illustrated in FIGS. 4 to 9. Therefore, the acquired captured image of the two-dimensional code 450a is distorted, as illustrated in FIG. 17A. In this distorted state, the two-dimensional code 450a in the captured image is unreadable. If the two-dimensional code 450a in the acquired captured image is readable (NO at step S32-2), the reading unit 14 proceeds to the process of step S32-5. If the two-dimensional code 450a in the acquired captured image is unreadable (YES at step S32-2), the reading unit 14 proceeds to the process of step S32-3.

The reading unit 14 then identifies the projection method of the lenses 102 of the image capturing apparatus 10 (step S32-3). In the present example, the image capturing apparatus 10 is the special image capturing apparatus illustrated in FIGS. 4 to 9. Therefore, the reading unit 14 identifies the projection method of the lenses 102 of the image capturing apparatus 10 as the equirectangular projection method. The reading unit 14 then performs conversion with equation (2) given below, to thereby generate a corrected image (step S32-4).

$$\begin{matrix} [ Math . 2 ] & \\ \{ \begin{matrix}{x}_{c} = \frac{{x}_{ED}}{\sqrt{\text{?} + \text{?}}} f tan \frac{\sqrt{\text{?} + \text{?}}}{f} \\ {y}_{c} = \frac{{y}_{ED}}{\sqrt{\text{?} + \text{?}}} f tan \frac{\sqrt{\text{?} + \text{?}}}{f}\end{matrix} \\ \text{?} \text{indicates text missing or illegible when filed} & ( 2 )\end{matrix}$$

Specifically, with equation (2), the reading unit 14 generates the corrected image by converting the coordinates of the captured image according to the equirectangular projection method identified at step S32-3 into the coordinates according to the central projection method. In equation (2), x and y represent the coordinates on the image capturing plane (see FIG. 17B), and x_{c} and y_{c} represent the coordinates according to the central projection method. Further, x_{ED} and y_{ED} represent the coordinates according to the equirectangular projection method. With equation (2), the reading unit 14 thus converts the coordinates x_{ED} and y_{ED} of the acquired captured image according to the equirectangular projection method into the coordinates x_{c} and y_{c} according to the central projection method, to thereby generate the corrected image represented by the converted coordinates x_{c} and y_{c} according to the central projection method. Equation (2) described above varies depending on the type of the lenses 102 employed in the image capturing apparatus 10. An appropriate conversion equation is selected based on the projection method identified at step S32-3. Consequently, the image capturing apparatus 10 is capable of acquiring the setting information embedded in the two-dimensional code 450a regardless of the type of the lenses 102 employed in the image capturing apparatus 10.

The reading unit 14 reads the two-dimensional code 450a in the captured image acquired at step S32-1 or in the corrected image generated at step S32-4 (step S32-5). Then, the setting information processing unit 15 deploys the two-dimensional code 450a read at step S32-5, to thereby acquire the setting information embedded in the two-dimensional code 450a (step S32-6).

As described above, the image capturing apparatus 10 acquires the setting information for using the content distribution service by reading the two-dimensional code 450a displayed on the communication terminal 30.

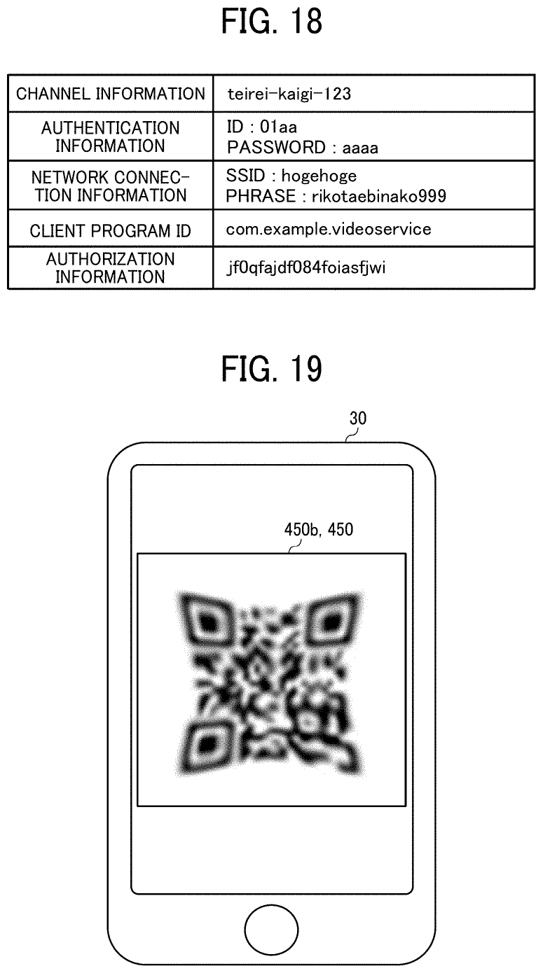

The setting information acquired at step S32-6 will be described with FIG. 18.

FIG. 18 is a conceptual diagram illustrating exemplary setting information included in the two-dimensional code 450 of the first embodiment. The setting information acquired by the setting information processing unit 15 includes the channel information for identifying the channel of the content distribution service to be used, the authentication information for the content distribution system 50 to use in the user authentication, the network connection information to be used to connect to the communication network 5, the client program identification information (i.e., client program ID) 5005 for identifying the client program 7001 for enabling the image capturing apparatus 10 to use the content distribution service, and the authorization code for identifying the access right of the user to the content distribution service. The channel information, the authentication information including the user ID and the password, and the network connection information including the SSID and the pass phrase are information input by the user on the setting screen 200 displayed on the communication terminal 30. The client program ID and the authorization code are information managed by the content distribution system 50. The image capturing apparatus 10 reads the two-dimensional code 450a to acquire the setting information embedded in the two-dimensional code 450a.

Referring back to FIG. 15, the transmitting and receiving unit 11 of the image capturing apparatus 10 transmits a network connection request to the router 90 to request connection to the communication network 5 (step S33). The network connection request includes the network connection information included in the setting information acquired at step S32-6. Then, the transmitting and receiving unit 91 of the router 90 receives the network connection request transmitted from the image capturing apparatus 10. With the network connection information received at step S33, the router 90 performs network connection to the image capturing apparatus 10 (step S34). Thereby, the network control unit 16 of the image capturing apparatus 10 establishes the connection to the communication network 5 via the router 90.

Then, the transmitting and receiving unit 11 of the image capturing apparatus 10 transmits a client program acquisition request to the client program distribution system 70 to request download of the client program 7001 (step S35). The client program acquisition request includes the client program identification information 5005 included in the setting information acquired at step S32-6. Then, the transmitting and receiving unit 71 of the client program distribution system 70 receives the client program acquisition request transmitted from the image capturing apparatus 10. The transmitting and receiving unit 71 then transmits the client program 7001 stored in the storage unit 7000 to the image capturing apparatus 10 (step S36). Then, the transmitting and receiving unit 11 of the image capturing apparatus 10 receives (i.e., downloads) the client program 7001.

The client program managing unit 17 of the image capturing apparatus 10 installs and starts the client program 7001 received at step S36 (step S37). Then, with the started client program 7001, the transmitting and receiving unit 11 transmits a connection request to the content distribution system 50 to request connection to the content distribution service (step S38). The connection request includes the authentication information (i.e., the user ID and the password) included in the setting information acquired at step S32-6. Then, the transmitting and receiving unit 51 of the content distribution system 50 receives the connection request transmitted from the image capturing apparatus 10.

With the authentication information received by the transmitting and receiving unit 51, the authentication unit 52 of the content distribution system 50 executes the authentication process for the user of the image capturing apparatus 10 (step S39). Specifically, the authentication unit 52 performs a search through the authentication management table (see FIG. 11A) with the search key set to the user ID and the password included in the connection request received by the transmitting and receiving unit 51. If the same user ID and password as those in the connection request are managed in the authentication management table, the authentication unit 52 allows the user the image capturing apparatus 10 to connect (i.e., log in) to the content distribution service. If the same user ID and password as those in the connection request are managed in the authentication management table, the processes described below are executed. Further, the authorization information managing unit 54 performs a search through the authorization information management table (see FIG. 11B) with the search key set to the authorization code included in the connection request received by the transmitting and receiving unit 51, and grants the user of the image capturing apparatus 10 the access right associated with the authorization code.

Then, the transmitting and receiving unit 51 transmits the authorization information including the granted access right to the image capturing apparatus 10 (step S40). Then, the transmitting and receiving unit 11 of the image capturing apparatus 10 receives the authorization information transmitted from the content distribution system 50. The transmitting and receiving unit 11 of the image capturing apparatus 10 then transmits the image data of the image captured by the image capturing unit 13 to the content distribution system 50 (step S41). Thereby, the image capturing apparatus 10 distributes the image data of the captured image to the content distribution system 50 via the communication network 5.

As described above, according to the communication system 1a, the image capturing apparatus 10 captures the image of the two-dimensional code 450a displayed on the communication terminal 30, and reads the two-dimensional code 450a to acquire the setting information embedded therein. The communication system 1a thereby enables simple setting of image distribution with the image capturing apparatus 10.

According to a typical communication system, an image capturing apparatus has a dedicated network interface (e.g., network card) for communication with a communication terminal. Therefore, the connection to the Internet is unavailable during the setting of image distribution with the communication terminal. However, the authorization information of the content distribution service is often acquired via the Internet, and the actual distribution of content involves the connection to the Internet. Consequently, switching of the network connection frequently occurs during the setting operation, complicating the setting procedure. Further, to use multiple content distribution services, separate software applications (i.e., client programs) for the multiple content distribution services are typically preinstalled in the image capturing apparatus.

According to the communication system 1a of the present embodiment, on the other hand, the communication terminal 30 displays the two-dimensional code 450a, in which the setting information for using the content distribution service is embedded. Then, the image capturing apparatus 10 acquires the setting information by capturing the image of the displayed two-dimensional code 450a, and performs the setting for the image distribution with the acquired setting information. With the image capturing function of the image capturing apparatus 10, therefore, the communication system 1a simplifies the setup (i.e., setting) of the image distribution, obviating the switching of the network connection. Further, when the image capturing apparatus 10 is the special image capturing apparatus equipped with the wide-angle lenses 102, the image capturing apparatus 10 converts the captured image of the two-dimensional code 450a in accordance with the projection method of the lenses 102, to thereby acquire the setting information embedded in the two-dimensional code 450a. Accordingly, even if the image capturing apparatus 10 is the special image capturing apparatus equipped with the wide-angle lenses 102, for example, the setting information embedded in the two-dimensional code 450a is reliably acquired regardless of the type of the imaging device 101.

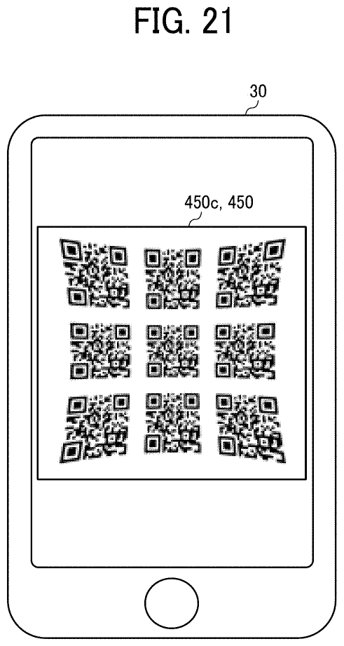

A first modified example of the two-dimensional code 450 displayed on the communication terminal 30 will be described with FIGS. 19 and 20.

FIG. 19 is a diagram illustrating the first modified example of the two-dimensional code 450 of the first embodiment displayed on the communication terminal 30. A two-dimensional code 450b illustrated in FIG. 19 is distorted from the two-dimensional code 450a illustrated in FIG. 14. The image capturing apparatus 10 is capable of acquiring the setting information embedded in the two-dimensional code 450b displayed on the communication terminal 30 by reading the two-dimensional code 450b.

A process of generating the two-dimensional code 450b illustrated in FIG. 19 will be described with FIG. 20.

FIG. 20 is a flowchart illustrating an exemplary process of generating the first modified example of the two-dimensional code 450. The process illustrated in FIG. 20 is executed at step S21 of FIG. 12.

The two-dimensional code generating unit 36 first generates the two-dimensional code 450a with the setting information generated at step S20 in FIG. 12 (step S21-1). The two-dimensional code 450a generated in this step is not distorted, as illustrated in FIG. 14. Then, the two-dimensional code generating unit 36 identifies the projection method of the lenses 102 of the image capturing apparatus 10 (step S21-2). In the present example, the image capturing apparatus 10 is the special image capturing apparatus illustrated in FIGS. 4 to 9. Thus, the two-dimensional code generating unit 36 identifies the equirectangular projection method as the projection method of the lenses 102 of the image capturing apparatus 10. It is assumed here that the information of the projection method of the image capturing apparatus 10 is stored in the communication terminal 30.

Then, based on the projection method identified at step S21-2, the two-dimensional code generating unit 36 determines whether the two-dimensional code 450a generated at step S21-1 should be corrected (step S21-3). If the projection method identified at step S21-2 is the central projection method, the two-dimensional code generating unit 36 determines that the two-dimensional code 450a does not need to be corrected. If the projection method identified at step S21-2 is a projection method other than the central projection method, the two-dimensional code generating unit 36 determines that the two-dimensional code 450a should be corrected. If having determined that the two-dimensional code 450a should be corrected (YES at step S21-3), the two-dimensional code generating unit 36 proceeds to the process of step S21-4. If having determined that the two-dimensional code 450a does not need to be corrected (NO at step S21-3), the two-dimensional code generating unit 36 completes the two-dimensional code generation process.

If having determined that the two-dimensional code 450a should be corrected (YES at step S21-3), the two-dimensional code generating unit 36 converts the two-dimensional code 450a into a two-dimensional code according to the projection method identified at step S21-2, to thereby generate a corrected two-dimensional code (step S21-4). Specifically, the two-dimensional code generating unit 36 generates the two-dimensional code 450b with equation (2) described above. In equation (2), x_{c} and y_{c} represent the coordinates of the two-dimensional code 450a generated at step S21-1, and x_{ED} and y_{ED} represent the coordinates according to the equirectangular projection method obtained through the conversion. With equation (2), the two-dimensional code generating unit 36 thus converts the coordinates x_{c} and y_{c} of the two-dimensional code 450a generated at step S21-1 into the coordinates x_{ED} and y_{ED} according to the equirectangular projection method. The two-dimensional code generating unit 36 then generates the two-dimensional code 450b represented by the coordinates x_{ED} and y_{ED} according to the equirectangular projection method obtained through the conversion. Herein, equation (2) varies depending on the type of the lenses 102 employed in the image capturing apparatus 10, and an appropriate conversion equation is selected based on the projection method identified at step S21-2.

When the image capturing apparatus 10 reads the distorted two-dimensional code 450b displayed on the communication terminal 30, therefore, the two-dimensional code 450b is read as a normal (i.e., undistorted) two-dimensional code (e.g., the two-dimensional code 450a). In this case, the two-dimensional code 450b is readable in the setting information acquisition process of the image capturing apparatus 10 in FIG. 16 (NO at step S32-2). Therefore, the image capturing apparatus 10 is capable of acquiring the setting information embedded in the two-dimensional code 450b without generating the corrected image. Except for the two-dimensional code generation process illustrated in FIG. 20, similar processes to those illustrated in FIGS. 12 and 15 are executed in the present example.

A second modified example of the two-dimensional code 450 displayed on the communication terminal 30 will be described with FIG. 21.

FIG. 21 is a diagram illustrating the second modified example of the two-dimensional code 450 of the first embodiment displayed on the communication terminal 30. Unlike the two-dimensional code 450b illustrated in FIG. 19, a two-dimensional code 450c illustrated in FIG. 21 includes a plurality of two-dimensional codes. Further, in the two-dimensional code 450c, the entirety of the plurality of two-dimensional codes displayed on the display 317 is distorted. To display such a two-dimensional code 450c, the communication terminal 30 generates the two-dimensional code 450c with the two-dimensional code generation process illustrated in FIG. 20. Similarly as in the example of the two-dimensional code 450b, the image capturing apparatus 10 is capable of reading the setting information embedded in the two-dimensional code 450c without the corrected image generation process illustrated in FIG. 16.

A communication system 1b of a second embodiment of the present invention will be described. The same components and functions as those in the first embodiment will be denoted with the same reference numerals, and description thereof will be omitted.

In the communication system 1b of the second embodiment, the process of generating the two-dimensional code 450 to be displayed on the communication terminal 30 is executed by the content distribution system 50.

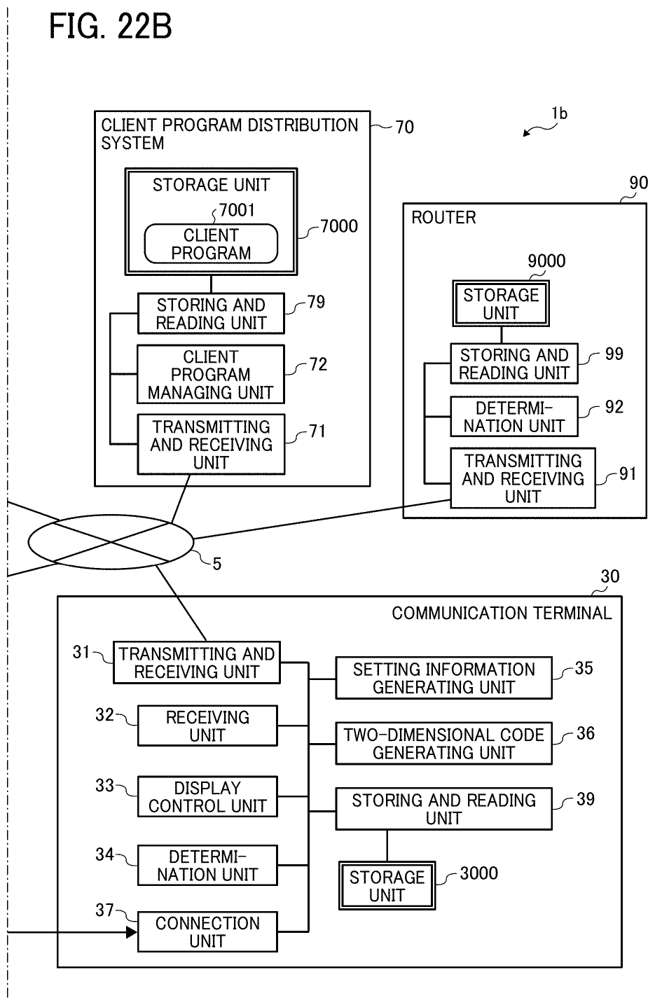

A functional configuration of the communication system 1b of the second embodiment will be described with FIGS. 22A and 22B.

FIGS. 22A and 22B are diagrams illustrating an exemplary functional configuration of the communication system 1b of the second embodiment. In FIGS. 22A and 22B, the functions of the apparatuses and terminal except the content distribution system 50 are similar to those illustrated in FIGS. 10A and 10B, and thus description thereof will be omitted. The content distribution system 50 includes, as well as the functions thereof illustrated in FIG. 10A, a setting information generating unit 56 and a two-dimensional code generating unit 57.

The setting information generating unit 56 is a function implemented by a command from the CPU 501 in FIG. 3 to generate the setting information for using the content distribution service.

The two-dimensional code generating unit 57 is a function implemented by a command from the CPU 501 in FIG. 3 to generate the two-dimensional code 450 with the setting information generated by the setting information generating unit 56.

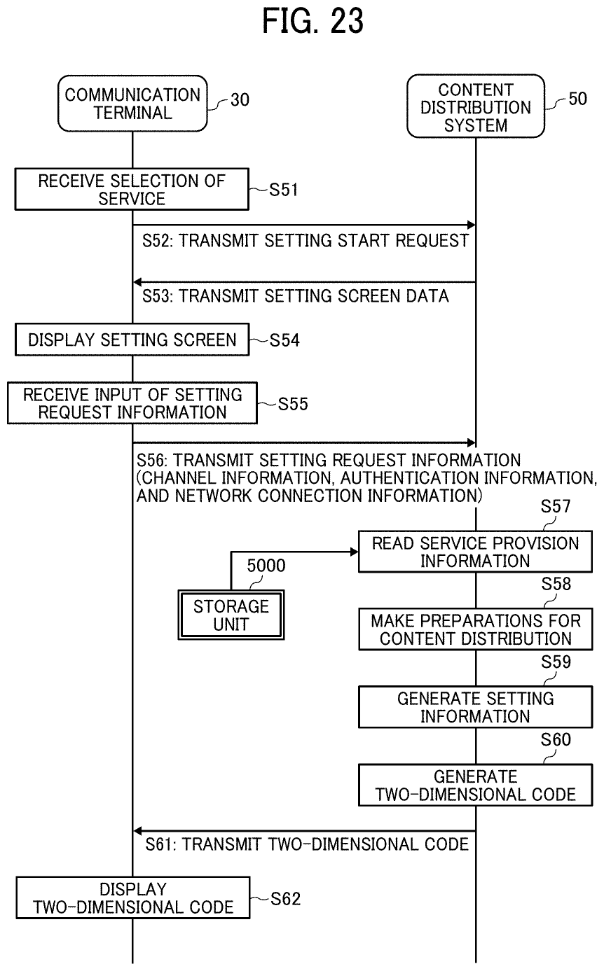

Processes and operations performed in the communication system 1b of the second embodiment will be described with FIG. 23.

FIG. 23 is a sequence diagram illustrating an exemplary content distribution process performed in the communication system 1b of the second embodiment. The processes of steps S51 to S58 are similar to those of steps S11 to S18 in FIG. 12, and thus description thereof will be omitted.

The setting information generating unit 56 generates the setting information for using the content distribution service (step S59). Herein, the setting information includes the setting request information received at step S56 and the service provision information read at step S57.

The two-dimensional code generating unit 57 generates the two-dimensional code 450 with the setting information generated at step S59 (step S60). A method of generating the two-dimensional code 450 employed in this step is similar to that illustrated in FIG. 20, and thus description thereof will be omitted. Then, the transmitting and receiving unit 51 transmits the two-dimensional code 450 generated at step S60 to the communication terminal 30 (step S61). Then, the transmitting and receiving unit 31 of the communication terminal 30 receives the two-dimensional code 450 transmitted from the content distribution system 50. Then, the display control unit 33 of the communication terminal 30 controls the display 317 to display the two-dimensional code 450 received at step S61 (step S62). Subsequent processes are similar to the processes of steps S31 to S41 illustrated in FIG. 15, and thus description thereof will be omitted.

As described above, according to the communication system 1b of the second embodiment, in which the two-dimensional code 450 having the setting information embedded therein is generated by the content distribution system 50, the setup (i.e., setting) of the image distribution in the image capturing apparatus 10 is simplified similarly as in the communication system 1a of the first embodiment.

As described above, the image capturing apparatus 10 of the foregoing embodiments of the present invention is capable of executing the image distribution without network switching. Consequently, the setting of the image distribution is simplified.

Further, according to the communication system 1a of the first embodiment and the communication system 1b of the second embodiment, the communication terminal 30 displays the two-dimensional code 450 in which the setting information for using the content distribution service is embedded. Consequently, the setting of the image distribution by the image capturing apparatus 10 is performed with the image capturing function of the image capturing apparatus 10.

The various tables of the embodiments described above may be generated by machine learning. The mutually associated data items in each of the tables may be categorized by machine learning to obviate the need for the tables. Herein, machine learning refers to a technology for causing a computer to acquire learning ability similar to human learning ability. According to the technology, the computer autonomously generates, from previously learned data, algorithms for making decisions such as data identification, and makes predictions by applying the algorithms to new data. The learning method for machine learning may be any of supervised learning, unsupervised learning, semi-supervised learning, reinforcement learning, and deep learning, or may be a learning method combining two or more of these learning methods. The learning method for machine learning is not limited to a particular method.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

Further, in this disclosure, the spherical image does not have to be the full-view spherical image of a full 360 degrees in the horizontal direction. For example, the spherical image may be a wide-angle view image having an angle of anywhere from 180 to any amount less than 360 degrees in the horizontal direction. It is desirable that the spherical image is image data having at least a part that is not entirely displayed in the viewable area. The image, if desired, can be made up of multiple pieces of image data which have been captured through different lenses, or using different image sensors, or at different times. Moreover, the image capturing apparatus may capture any desired code, other than the two-dimensional code, as long as the code contains information required for the image capturing apparatus to connect to a particular network used for distributing image data.

1. An image capturing apparatus comprising:
an imaging device configured to capture an image of a subject to acquire image data; and
circuitry configured to
read a two-dimensional code displayed on a communication terminal and acquired with the imaging device,
acquire setting information for using a service provided by a content distribution system that distributes content via a communication network, the setting information being represented by the read two-dimensional code,
connect the image capturing apparatus to the communication network with network connection information included in the acquired setting information, and
distribute the image data acquired by the imaging device to the content distribution system via the communication network connected to the image capturing apparatus.

2. The image capturing apparatus of claim 1, wherein the circuitry
downloads, via the communication network, a dedicated program for distributing the image data to the content distribution system, and
distributes the image data to the content distribution system with the downloaded dedicated program.

3. The image capturing apparatus of claim 1, wherein the circuitry
transmits authentication information for the content distribution system to the content distribution system, the authentication information being represented by the read two-dimensional code, and
distributes the image data to the content distribution system based on the authorization information representing an access right to the service, the access right being authenticated based on the authentication information.

4. The image capturing apparatus of claim 1, wherein the communication terminal is communicable with the content distribution system via the communication network.

5. The image capturing apparatus of claim 1, wherein the circuitry
identifies a projection method employed by the imaging device,
converts the read two-dimensional code from the identified projection method to a different projection method from the identified projection method to generate a corrected image, and
acquires the setting information represented by the corrected image.

6. The image capturing apparatus of claim 5, wherein the identified projection method of the imaging device is an equirectangular projection method, and the different projection method is a central projection method.

7. A communication system comprising:
the image capturing apparatus of claim 1; and
a communication terminal including second circuitry configured to
receive an input of setting request information for requesting settings for using the content distribution system,
transmit the received setting request information to the content distribution system, and
control a display to display the two-dimensional code representing the setting information, the setting information including the setting request information and service provision information for providing the service to a user.

8. The communication system of claim 7, wherein the second circuitry
receives the service provision information from the content distribution system,
generates the two-dimensional code with the received setting request information and the received service provision information, and
controls the display to display the generated two-dimensional code.

9. The communication system of claim 7, further comprising a content distribution system including third circuitry configured to
receive the setting request information transmitted from the communication terminal,
generate the two-dimensional code with the received setting request information and the service provision information stored in a memory, and
transmit the generated two-dimensional code to the communication terminal.

10. The communication system of claim 8, wherein the second circuitry generates the two-dimensional code through conversion according to a projection method employed by the imaging device.

11. The communication system of claim 9, wherein the third circuitry generates the two-dimensional code through conversion according to a projection method employed by the imaging device.

12. The communication system of claim 7, wherein the setting request information includes the network connection information, authentication information for the content distribution system, and channel information for identifying a distribution implemented on the service, and
wherein the service provision information includes authorization information representing an access right to the service and dedicated program identification information for identifying a dedicated program for transmitting the image to the content distribution system.

13. The communication system of claim 7, wherein the content distribution system distributes an image transmitted from the image capturing apparatus.

14. A data distribution method executed by an image capturing apparatus, the data distribution method comprising:
capturing an image of a subject with an imaging device of the image capturing apparatus to acquire image data;
reading a two-dimensional code displayed on a communication terminal and acquired with the imaging device;
acquiring setting information for using a service provided by a content distribution system that distributes content via a communication network, the setting information being represented by the read two-dimensional code;
connecting the image capturing apparatus to the communication network with network connection information included in the acquired setting information; and
distributing the image data acquired by the imaging device to the content distribution system via the communication network connected to the image capturing apparatus.

15. A non-transitory recording medium storing a plurality of instructions which, when executed by one or more processors, cause the processors to perform a data distribution method executed by an image capturing apparatus, the data distribution method comprising:
capturing an image of a subject with an imaging device of the image capturing apparatus to acquire image data;
reading a two-dimensional code displayed on a communication terminal and acquired with the imaging device;
acquiring setting information for using a service provided by a content distribution system that distributes content via a communication network, the setting information being represented by the read two-dimensional code;
connecting the image capturing apparatus to the communication network with network connection information included in the acquired setting information; and
distributing the image data acquired by the imaging device to the content distribution system via the communication network connected to the image capturing apparatus.
